(19) United States
(12) Patent Application Publication
(10) Pub. No.: US 2022/0369596 A1
(43) Pub. Date: Nov. 24, 2022

(54) Pet Leash Assembly

(71) Applicants: Artelia Butler, Front Royal, VA (US); Lakavious Roy, Front Royal, VA (US)

(72) Inventors: Artelia Butler, Front Royal, VA (US); Lakavious Roy, Front Royal, VA (US)

(21) Appl. No.: 17/732,754

(22) Filed: Apr. 29, 2022

Related U.S. Application Data
(60) Provisional application No. 63/189,889, filed on May 18, 2021.

(51) Int. Cl. A01K 27/00

(52) U.S. Cl. CPC A01K 27/003; A01K 27/005

(57) ABSTRACT

The present invention relates to an improved pet leash for use with two or more pets, such as dogs, that enables a pet owner to control two or more dogs and allows two or more dogs to be walked simultaneously. The leash allows one animal or dog to control or guide the movements and speed of another dog, thereby enabling the first animal to function as a ‘pack leader’ and guide the second animal on how to properly walk or heel on a leash. The leash maintains proximity between the dogs and prevents dogs from running off and jumping on the owner or others, ultimately keeping people and animals safe. The leash offers a way for pet owners, kennel employees and many others to keep optimal control over a plurality of dogs simultaneously on one leash.

### CROSS-REFERENCE TO RELATED APPLICATION

The present application claims priority to, and the benefit of, U.S. Provisional Application No. 63/189,889, which was filed on May 18, 2021 and is incorporated herein by reference in its entirety.

### FIELD OF THE INVENTION

The present invention relates generally to pet leash assemblies. More specifically, the present invention relates to a multi-pet leash assembly that is designed to have at least two attachment points for multiple animals. The leash allows one animal to control the movement and speed of the other, enabling the first animal to function as a ‘pack leader’ and teach the second animal how to properly walk on a leash. The leash includes an adjustable loop for handling the leash and clasps for attaching to collars of the animals or dogs. Accordingly, the present disclosure makes specific reference thereto. Nonetheless, it is to be appreciated that aspects of the present invention are also equally applicable to other like applications, devices, and methods of manufacture.

### BACKGROUND

By way of background, leashes are utilized by pet owners, kennel employees, and many others for the safety, convenience and the health of their pets. Dog leashes are primarily designed to control the mobility of dogs while being walked, to prevent them from straying off, and to direct the path in which they walk. The obvious benefits of walking dogs also include giving them an opportunity to exercise, interact with other dogs and the environment, and enable dogs to engage in the necessary act of relieving themselves. Traditional dog leashes can be effective; however, a dog can start to run out of control or get excited and jump on a pet owner. Traditional leashes also can allow a dog to cut corners, jump on others, etc. which may lead to injury to the pet or others. Some dogs initially are not accustomed to walking with leashes, and thus can become restless and uncontrollable. Some of these pets may require additional training and this can prevent pet owners from using leashes until their pets receive particular training. A convenient way of teaching dogs and other pets to walk with leashes is to allow them to walk with a trained dog, however, traditional leashes do not allow dogs to operate like this.

Also, most heretofore known dog leashes are designed for the operation and control of one dog. Those leashes are disadvantageous for those owners/operators or facilities that own, or have in their custody, more than one dog that needs to be controlled while being walked with another dog. Thus, such owners are required to buy more than one leash and walk with separate leashes using two hands, or hold all of the leashes with one hand. In such cases, all the dogs are independent and movement of one dog cannot be controlled by another dog. Dogs who are trained cannot control the movement of the untrained dogs and this can cause problems for the pet owner as dogs may lag or not remain proximate to each other.

Therefore, there exists a long felt need in the art for an improved animal leash that can be used for at least two animals, especially dogs, simultaneously. There is also a long felt need in the art for an improved dog leash that includes multiple attachment points for dogs. Additionally, there is a long felt need in the art for an improved dog leash that allows one dog to control the movement and speed of the other dog. Moreover, there is a long felt need in the art for an improved animal leash that allows multiple attached pets to remain proximate to each other. Furthermore, there is a long felt need in the art for an improved dog leash that prevents dogs from running off and jumping on the owner or others, ultimately keeping people and pets safe. Finally, there is a long felt need in the art for an improved animal leash that offers a way for pet owners and others to keep optimal control over multiple dogs on the leash without excessive pulling on the leash.

The subject matter disclosed and claimed herein, in one embodiment thereof, comprises a multiple dog leash for attaching and controlling multiple dogs simultaneously. The dog leash is designed to have multiple attachment points for dogs. The dog leash includes a primary flexible strap having a first end and a second end. The first end includes an adjustable loop formed by the flexible strap slidably connected onto itself and is grasped by a user, the second end includes a plurality of fastened flexible leash straps wherein each flexible leash strap includes a first end and a second end. The first end of each flexible leash strap is fastened to the second end of the primary flexible strap and the second end includes a clasp for attaching to a dog's collar. One flexible leash strap of the plurality of flexible leash straps is longer than the other leash straps, and allows the dog attached to the longer flexible leash strap to act as a pack leader and control the movements of the other dogs attached to the other flexible leash straps.

In this manner, the multiple dog leash assembly of the present invention accomplishes all of the forgoing objectives and provides users with a multiple dog leash that can be used for controlling multiple dogs simultaneously. The leash eliminates the need for a pet owner to carry a plurality of leashes to control multiple dogs or animals. The leash enables the attached dogs to remain in close proximity and thus prevents the dogs from running off and jumping on the owner or others. The leash allows the owner to maintain full control while minimizing movements of the pets, and can be useful for pet owners, kennel clubs, service dogs, military and police dogs and more

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dog leash for controlling multiple dogs. The dog leash is designed to have multiple attachment points for multiple dogs. The dog leash further comprises a primary flexible strap having a first end and a second end, the first end includes an adjustable loop formed by the flexible strap slidably connected onto itself, the second end includes a plurality of fastened flexible leash straps wherein each flexible leash strap includes a first end and a second end. The first end of each flexible leash strap is fastened to the second end of the primary flexible strap, and the second end of each flexible strap includes a clasp for attaching to a dog's collar. One flexible leash strap of the plurality of flexible leash straps is longer than the other leash straps and allows the dog attached to the longer flexible leash strap to act as a pack leader and assist with controlling movements of the other dogs attached to the other flexible leash straps.

In yet another embodiment, three flexible leash straps are removably-fastened to the primary flexible strap. In yet another embodiment, the primary strap and the flexible straps are made from one or more material of a leather, a nylon or any other fabric known in the art.

In yet another embodiment, a length of the primary strap can be in the range from about 5 feet to about 8 feet, the length of the longer flexible leash strap can be in the range from about 3 feet to about 5 feet, and the length of other flexible leash straps can be in the range from about 2 feet to about 4 feet. In yet another embodiment, a length of all flexible leash straps can be different, and thus prevents tangling of the leash straps.

The subject matter disclosed and claimed herein, in another embodiment thereof, comprises a dog leash for multiple dogs. The dog leash further comprises a primary flexible handle having a first end and a second end, wherein the second end is opposite to the first end. The first end of the primary handle can include an adjustable loop formed by the handle slidably-connected onto itself for holding and gripping the leash by a user. The second end of the primary handle can include a clasp receiving loop for receiving clasps. Further, the dog leash includes a first dog leash attachment strap having a first end and a second end. The first end of the first dog leash includes a first clasp for attaching to the clasp receiving loop of the primary flexible handle, and the second end of the first dog leash includes a second clasp for attaching to a first dog's collar. Similarly, the dog leash includes a second dog leash attachment strap having a first end and a second end. The first end of the second dog leash includes a first clasp for attaching to the clasp receiving loop of the primary flexible handle, and the second end of the second dog leash includes a second clasp for attaching to a second dog's collar, wherein the first dog leash attachment strap is longer than the second dog leash attachment strap, and both the straps are simultaneously attached to the primary flexible handle. The first dog attached to the first dog leash attachment strap acts as a ‘pack leader’ or primary dog, and teaches or leads a following dog or secondary dog attached to the second dog leash attachment strap how to properly walk on a leash while maintaining proximity between the two dogs.

In yet another embodiment, the dog leash maintains proximity between the dogs attached to the leash attachment straps and allows the first (primary) dog to assist with controlling the movements of the second (secondary) dog in which both dogs must move together with one associated to the other.

In yet another embodiment of the present invention, a method of coupling multiple dogs to a leash is described. The method includes the steps of: providing a primary flexible strap having a first end and a second end, the first end includes an adjustable loop formed by the flexible strap slidably-connected onto itself; providing a pack leader leash strap having a first end removably-fastened to the second end of the primary flexible strap, and a second end having a clasp; providing another dog leash strap having a first end removably-fastened to the second end of the primary flexible strap and a second end having a clasp; connecting the clasp of the pack leader leash strap to the pack leader dog's collar; connecting the clasp of the another dog leash strap to the another dog's collar; and, controlling the movements of both the dogs by pulling the primary flexible strap enabling the dogs to be move in close proximity and enabling the pack leader to teach or guide another dog how to properly walk on a leash.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multiple pet leash of the present invention in accordance with the disclosed architecture;

FIG. 2 illustrates a perspective view showing a user holding the multi-pet leash assembly of FIG. 1 with two attached dogs in accordance with the disclosed architecture;

FIG. 3 illustrates an individual leash strap that can be used for making another embodiment of the multi-pet leash of the present invention in accordance with the disclosed architecture; and

FIG. 4 illustrates a perspective view showing another embodiment of a multi-pet leash assembly of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved animal leash that can be used for at least two animals, especially dogs, simultaneously. There is also a long felt need in the art for an improved dog leash that includes multiple attachment points for dogs. Additionally, there is a long felt need in the art for an improved dog leash that allows one dog to control the movement and speed of the other dog. Moreover, there is a long felt need in the art for an improved animal leash that allows multiple attached pets to remain proximate to each other. Furthermore, there is a long felt need in the art for an improved dog leash that prevents dogs from running off and jumping on the owner or others, ultimately keeping people and the pets safe. Finally, there is a long felt need in the art for an improved animal leash that offers a way for pet owners and others to keep optimal control over multiple dogs on the leash without excessive pulling on the leash.

The present invention, in one exemplary embodiment, includes a novel leash for multiple dogs or animals. The leash features a primary flexible handle having a first end and a second end, the first end having an adjustable loop for gripping the leash by a user, the second end including a clasp receiving loop for receiving clasps. Furthermore, the leash includes a first dog leash attachment strap having a first end and a second end, the first end includes a first clasp for attaching to the clasp receiving loop of the primary flexible handle and the second end includes a second clasp for attaching to a first dog's collar. Similarly, the leash includes a second dog leash attachment strap having a first end and a second end, the first end includes a first clasp for attaching to the clasp receiving loop of the primary flexible handle, and the second end includes a second clasp for attaching to a second dog's collar wherein the first dog leash attachment strap is longer than the second dog leash attachment strap and both the straps are simultaneously attached to the primary flexible handle.

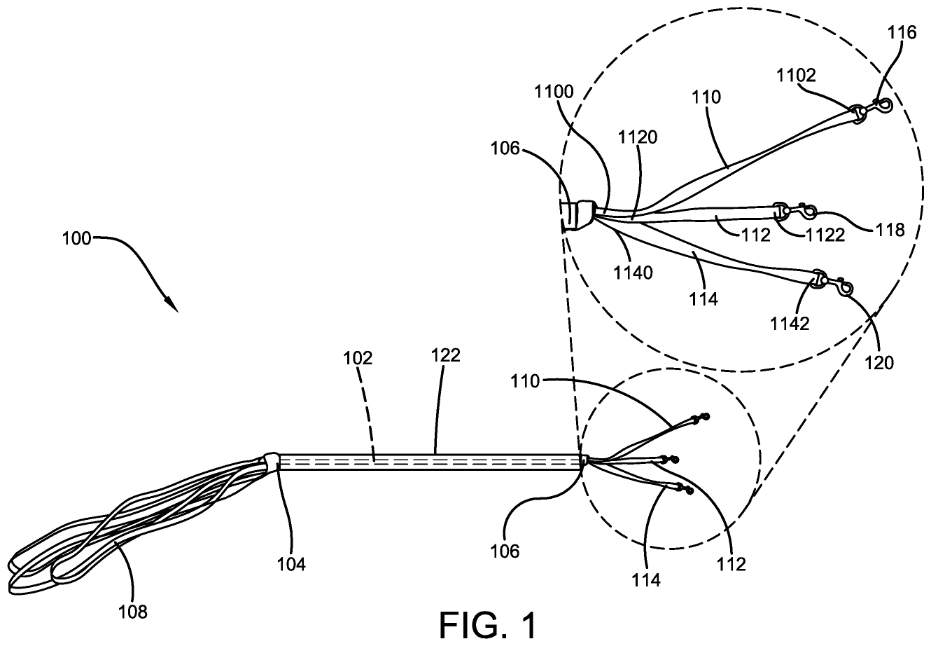

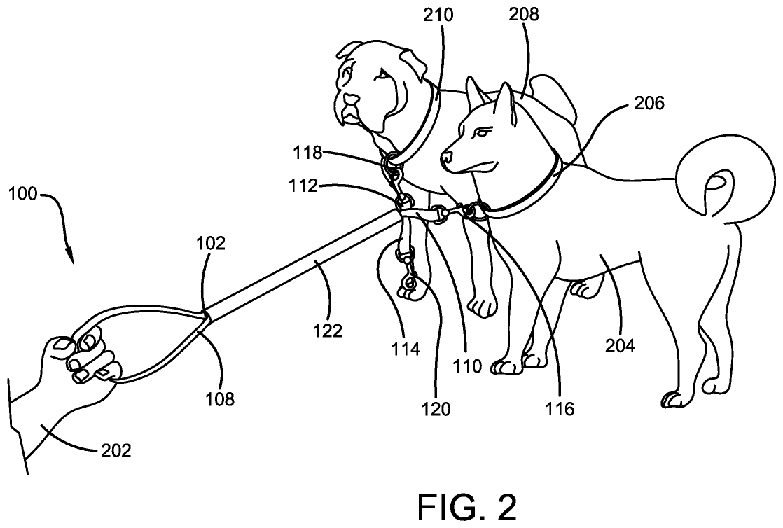

Referring initially to the drawings, FIG. 1 illustrates a perspective view of one potential embodiment of a multiple pet leash 100 of the present invention in accordance with the disclosed architecture. FIG. 1 shows several advantageous features of the present invention, but as will be described below, the invention can be provided in several shapes, sizes, combinations of features and components, and varying numbers and functions of the components. The multiple pet leash 100 is designed to simultaneously control two or more pets using multiple attachment points. More specifically, the multiple pet leash 100 includes a primary flexible strap 102 that has a first end 104 and a second end 106. The first end 104 includes an adjustable loop 108 formed by the flexible strap slidably-connected onto itself and the loop 108 is used by a user such as a pet owner for holding the leash 100. A plurality of flexible leash straps 110, 112, 114 are removably-fastened at the second end 106, wherein each of the flexible leash straps 110, 112, 114 are used for attaching the leash 100 to a pet such as a dog. The terms “removably-fastened” and “removably-attached” are defined herein as having the ability to attach to and be removed from another object with little effort. The first flexible leash strap 110 includes a first end 1100 and a second end 1102. The first end 1100 is fastened to the primary flexible strap's second end 106 using a fastening means such as a knot, a clasp-receiving pool or any other fastening means know in the art. The second end 1102 includes a clasp or snap hook 116 that is used for securing the first flexible leash strap 110 to a collar of a pet or dog as best shown in FIG. 2.

The second flexible leash strap 112 includes a first end 1120 and a second end 1122. The first end 1120 is fastened to the primary flexible strap's second end 106 using a fastening means such as a knot, a clasp receiving snap hook or any other fastening means known in the art. The second end 1122 includes a clasp or snap hook 118 that is used for securing the second flexible leash strap 112 to a collar of a second pet or dog as best shown in FIG. 2. Similarly, the third flexible leash strap 114 includes a first end 1140 and a second end 1142. The first end 1140 is fastened to the primary flexible strap's second end 106 using a fastening means such as a knot, a clasp receiving snap hook, or any other fastening means known in the art. The second end 1142 includes a clasp or snap hook 120 that is used for securing the third flexible leash strap 114 to a collar of a third pet or dog.

It should be noted that the flexible leash straps 110, 112, 114 are removably-attached to the primary flexible strap 102 and can be removed or attached as per the desires and requirements of a pet owner. The lengths of the flexible leash straps 110, 112, 114 can be of the same length or can be of different lengths. In one potential embodiment, one of the flexible leash straps 110, 112, 114 is longer than the other leash straps allowing a pet owner to use the longer strap for a trained pet or ‘lead’ dog. The trained pet or ‘lead’ dog can then control the movements and speed of the other dogs or pets attached to the leash 100, enabling the trained pet or ‘lead’ dog to function as a ‘pack leader’, and teach or guide other pets to properly walk on a leash.

For providing additional support to the leash and especially to the primary flexible strap 102, a lightweight handle 122 covers the primary flexible strap 102. The lightweight handle 122 is hollow, and can be made from a light-weight resilient material, such as hardened plastic, aluminum, or the like. It should be appreciated that the multi-pet leash 100 of the present invention eliminates the use of carrying multiple leashes by a pet owner and allows the pets to be walked in close proximity to each other. The leash assembly 100 allows the user to control one or more dogs or pets connected thereto.

The primary flexible strap 102 and the flexible leash straps 110, 112, 114 are machine washable and can be made from one or more materials selected from a plastic, a nylon, a leather or other flexible materials. The material can be chosen based on the strength or weight of the pet or dog to be attached with the leash 100 of the present invention.

FIG. 2 illustrates a perspective view showing a user holding the multi-pet leash assembly 100 of FIG. 1 with two attached dogs in accordance with the disclosed architecture. FIG. 2 illustrates a user 202 using the multi-pet leash 100 to control two dogs 204 and 208 where the first dog 204 is coupled to the first flexible leash strap 110 and the second dog 208 is coupled to the second flexible leash strap 112. The clasp 116 of the first flexible leash strap 110 is shown here removably-coupled to a first dog collar 206. Similarly, the clasp 118 of the second flexible leash strap 112 is shown here removably-coupled to a second dog collar 210. The third flexible leash strap 114 is shown in FIG. 2 not attached to any dog and can also be unfastened or removed. For controlling the dogs 204, 208, the user 202 holds the leash assembly 100 using the adjustable loop 108 and the leash assembly 100 can be pulled to control the dogs 204, 208. The primary strap 102 covered by the handle 122 includes a length that makes the control of multiple dogs 204, 208 easy to maintain.

For those users that have more than one dog and, in particular, users wishing to simultaneously control and walk the dogs, the two dogs can be coupled to the leash assembly 100. One of the dogs, the first dog 204 in the present embodiment, can function as a ‘pack leader’ and assist in teaching, guiding or controlling the second dog 208 on how to properly walk or heel on a leash and can also control the movement and speed of the second dog 208. The dogs can remain in close proximity to each other, and thus preventing them from running off and/or jumping on the owner or others, ultimately keeping people and the animals safe.

When the owner walks the dogs 204, 208 in areas where a wide distance range of motion would pose a hazard to the animals or others, the owner can pull the primary strap 102, thereby restricting the range of motion of the dogs. The dogs 204, 208, irrespective of their size, strength, weight or activity levels can roam in different directions. As the dogs 204, 208 begin to exert tension on their respective flexible leash straps, the pack leader or guide dog can control or exert resistance to the other dog, thereby obviating excessive pulling on the leash by the user that can cause callouses and blisters.

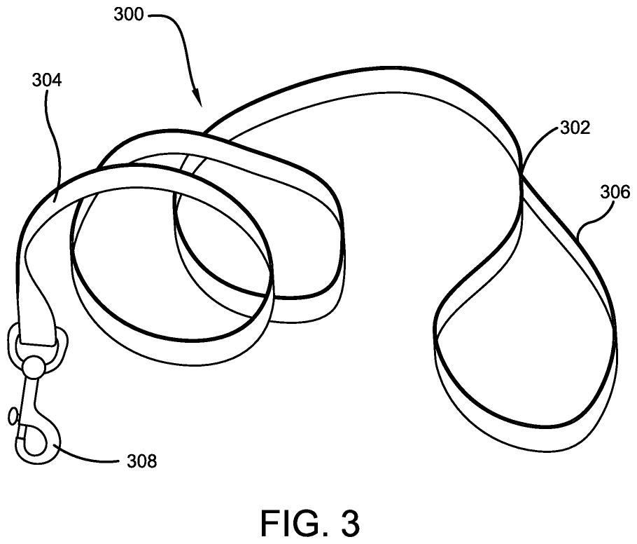

FIG. 3 illustrates an individual leash strap that can be used for making another embodiment of the multi-pet leash 100 of the present invention in accordance with the disclosed architecture. In the present embodiment, three individual leashes such as the exemplary individual leash 300 are fastened together at two ends to form a multi-pet leash that can be held by a user in a single hand and allows the pets or dogs to be in proximity of each other. Preferably, the leashes are fastened through a fastening means such as a knot, stitching, or through snap buttons at a first location 302 near the handle 306, and at a second location 304 near the clasp 308. The second location 304 can be at a distance in the range of from about 2 feet to about 4 feet from the clasp 308. It is to be appreciated that the length of each leash 300 between the first location 302 and the second location 304 acts as the primary leash strap 102 and can be covered by the handle 122 of FIG. 1.

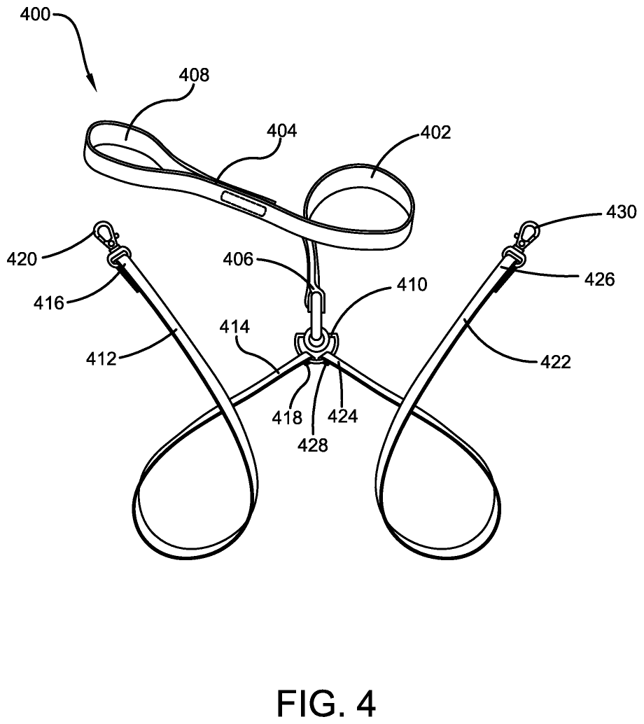

FIG. 4 illustrates a perspective view showing another embodiment of the multi-pet leash assembly of the present invention in accordance with the disclosed architecture. The multi-pet leash assembly 400 of the present embodiment includes a primary flexible handle 402 having a first end 404 and a second end 406, wherein the second end 406 is opposite to the first end 404. The first end 404 includes an adjustable loop 408 formed by the handle 402 slidably-connected onto itself for holding and gripping the leash assembly 400 by a user. The second end 406 of the handle 402 includes a clasp receiving loop 410. A separate first dog leash attachment strap 412 includes a first end 414 and a second end 416 wherein the first end 414 includes a first clasp 418 for attaching to the clasp-receiving loop 410 of the primary flexible handle 402 and the second end 416 includes a second clasp 420 for attaching to a first dog's collar. Similarly, the dog leash includes a separate second dog leash attachment strap 422 that has a first end 424 and a second end 426. The first end 424 includes a first clasp 428 for attaching to the clasp-receiving loop 410 of the primary flexible handle 402 and the second end 426 includes a second clasp 430 for attaching to a second dog's collar. The first dog leash attachment strap 412 can be longer than the second dog leash attachment strap 422, and both the straps can be simultaneously-attached to the primary flexible handle 402. One of the dogs attached to the leash assembly 400, preferably, the pet or dog attached to the first dog leash attachment strap 412 acts as a ‘pack leader’ and teaches or guides the second pet or dog attached to the second dog leash attachment strap 422 how to properly walk or heel on a leash while maintaining proximity between the two dogs.

The clasps or swivel eye snap hooks used in the leash assembly 300 can be heavy-duty and are anti-rust. The straps can be made from soft leather or nylon, and can be soft for both pet and user comfort. The leash assembly 400 can come in various colors and is suitable for all ages of pets and dogs.

The leash assembly of various embodiments of the present invention reduces stress on the pet owner when walking two or more dogs and provides greater control for the owner while allowing one dog to control or guide movements of the other dog. The two or more dogs having different strengths, sizes, weights, or activity levels can roam more freely without interference by the other dog or dogs.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-pet leash assembly”, “multi-dog leash assembly”, “leash assembly”, “leash”, and “improved animal leash” are interchangeable and refer to the multi-pet leash assembly 100, 400 of the present invention.

Notwithstanding the forgoing, the multi-pet leash assembly 100, 400 of the present invention can be of any suitable size and configuration as is known in the art without affecting the overall concept of the invention, provided that it accomplishes the above-stated objectives. One of ordinary skill in the art will appreciate that the size, configuration and material of the multi-pet leash assembly 100, 400 as shown in the FIGS. are for illustrative purposes only, and that many other sizes and shapes of the multi-pet leash assembly 100, 400 are well within the scope of the present disclosure. Although the dimensions of the multi-pet leash assembly 100, 400 are important design parameters for user convenience, the multi-pet leash assembly 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet leash for restraining a plurality of pets, the pet leash comprising:
a primary flexible strap including a first end and a second end, wherein said first end comprises an adjustable loop formed by a strap slidably connected onto itself and said adjustable loop is for use by a user holding said pet leash;
a plurality of flexible leash straps removably fastened at said second end;
wherein each of said plurality of flexible leash straps attachable to an individual pet;
wherein said plurality of flexible leash straps comprises a first flexible leash strap including a first end and a second end;
wherein said first end of said first flexible leash strap is fastened to said primary flexible strap's second end;
wherein said second end of said first flexible leash strap comprises a snap hook for securing said first flexible leash strap to a collar of a first pet;
wherein said plurality of flexible leash straps comprises a second flexible leash strap including a first end and a second end;
wherein said first end of said second flexible leash strap is fastened to said primary flexible strap's second end;
wherein said second end of said second flexible leash strap includes a snap hook for securing said second flexible leash strap to a collar of a second pet; and
wherein said first flexible strap is longer than said second flexible strap.

2. The pet leash for restraining a plurality of pets of claim 1, wherein said plurality of flexible leash straps includes a third flexible leash strap having a first end and a second end, wherein said first end of said third flexible leash strap is fastened to said primary flexible strap's second end, and further wherein said second end of said third flexible leash strap comprises a snap hook for securing said third flexible leash strap to a collar of a third pet.

3. The pet leash for restraining a plurality of pets of claim 2, wherein said first flexible strap is longer than said third flexible strap.

4. The pet leash for restraining a plurality of pets of claim 3, wherein said second flexible strap is longer than said third flexible strap.

5. The pet leash for restraining a plurality of pets of claim 4, wherein said first flexible strap is selectively detachable from said primary flexible strap.

6. The pet leash for restraining a plurality of pets of claim 5, wherein said second flexible strap is selectively detachable from said primary flexible strap.

7. The pet leash for restraining a plurality of pets of claim 6, wherein said third flexible strap is selectively detachable from said primary flexible strap.

8. The pet leash for restraining a plurality of pets of claim 1, wherein said primary flexible strap comprises a handle therearound.

9. The pet leash for restraining a plurality of pets of claim 8, wherein said handle is comprised of a material selected from a group consisting of a plastic and an aluminum.

10. The pet leash for restraining a plurality of pets of claim 9, wherein said first flexible strap, said second flexible strap, and said third flexible strap comprises a material selected from a group consisting of a plastic, a nylon and a leather.

11. The pet leash for restraining a plurality of pets of claim 4, wherein said primary flexible strap has a length generally from about 5 feet to about 8 feet, and further wherein said first flexible strap has a length generally from about 3 feet to about 5 feet.

12. The pet leash for restraining a plurality of pets of claim 11, wherein said second flexible strap has a length generally from about 2 feet to about 4 feet.

13. The pet leash for restraining a plurality of pets of claim 12, wherein said third flexible strap has a length generally from about 2 feet to about 4 feet.

14. A pet leash for restraining a plurality of pets, the pet leash comprising:
a primary flexible strap including a first end and a second end, wherein said first end comprises an adjustable loop formed by a strap slidably connected onto itself and said adjustable loop is for use by a user holding said pet leash;
a plurality of flexible leash straps removably fastened at said second end;
wherein each of said plurality of flexible leash straps attachable to an individual pet;
wherein said plurality of flexible leash straps comprises a first flexible leash strap including a first end and a second end;
wherein said first end of said first flexible leash strap is fastened to said primary flexible strap's second end;
wherein said second end of said first flexible leash strap comprises a snap hook for securing said first flexible leash strap to a collar of a first pet;
wherein said plurality of flexible leash straps comprises a second flexible leash strap including a first end and a second end;
wherein said first end of said second flexible leash strap is fastened to said primary flexible strap's second end;
wherein said second end of said second flexible leash strap comprises a snap hook for securing said second flexible leash strap to a collar of a second pet;
wherein said primary flexible strap comprises a length generally from about 5 feet to about 8 feet;
wherein said first flexible strap comprises a length generally from about 3 feet to about 5 feet; and
further wherein said second flexible strap comprises a length generally from about 2 feet to about 4 feet.

15. The pet leash for restraining a plurality of pets of claim 14, wherein said plurality of flexible leash straps comprises a third flexible leash strap having a first end and a second end, wherein said first end of said third flexible leash strap fastened to said primary flexible strap's second end, and further wherein said second end of said third flexible leash strap includes a snap hook for securing said third flexible leash strap to a collar of a third pet.

16. The pet leash for restraining a plurality of pets of claim 15, wherein said second flexible strap is longer than said third flexible strap.

17. The pet leash for restraining a plurality of pets of claim 15, wherein said first flexible strap, said second flexible strap, and said third flexible strap are each selectively detachable from said primary flexible strap.

18. The pet leash for restraining a plurality of pets of claim 15, wherein said primary flexible strap includes a handle therearound, and further wherein said handle is comprised of a material selected from a group consisting of a plastic and an aluminum.

19. A pet leash for restraining a plurality of pets, the pet leash comprising:
a primary flexible strap including a first end and a second end, wherein said first end includes an adjustable loop formed by a strap slidably connected onto itself and said loop for use by a user holding said pet leash;
a plurality of flexible leash straps removably fastened at said second end;
wherein each of said plurality of flexible leash straps attachable to an individual pet;
wherein said plurality of flexible leash straps includes a first flexible leash strap including a first end and a second end;
wherein said first end of said first flexible leash strap fastened to said primary flexible strap's second end;
wherein said second end of said first flexible leash strap includes a snap hook for securing said first flexible leash strap to a collar of a first pet;
wherein said plurality of flexible leash straps includes a second flexible leash strap including a first end and a second end;
wherein said first end of said second flexible leash strap fastened to said primary flexible strap's second end;
wherein said second end of said second flexible leash strap includes a snap hook for securing said second flexible leash strap to a collar of a second pet;
wherein said plurality of flexible leash straps includes a third flexible leash strap including a first end and a second end;
wherein said first end of said third flexible leash strap fastened to said primary flexible strap's second end;
wherein said second end of said third flexible leash strap includes a snap hook for securing said third flexible leash strap to a collar of a third pet;
wherein said primary flexible strap includes a length generally from about 5 feet to about 8 feet;
wherein said first flexible strap includes a length generally from about 3 feet to about 5 feet;
wherein said second flexible strap includes a length generally from about 2 feet to about 4 feet;
wherein said primary flexible strap includes a handle therearound; and
further wherein said handle is comprised of a material selected from a group consisting of a plastic and an aluminum.

20. The pet leash for restraining a plurality of pets of claim 19, wherein said first flexible strap, said second flexible strap, and said third flexible strap are each selectively detachable from said primary flexible strap.
